(19) United States
(12) Patent Application Publication
(10) Pub. No.: US 2010/0318393 A1
(43) Pub. Date: Dec. 16, 2010

(54) DYNAMICALLY DISPATCHING WORKFLOWS IN RESPONSE TO WORKFLOW RULES

(75) Inventors: Warren P. Acker, Oronoco, MN (US); Richard J. Stevens, Rochester, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(73) Assignee: INTERNATIONAL BUSINESS MACHINES, CORPORATION, ARMONK, NY (US)

(21) Appl. No.: 12/482,603

(22) Filed: Jun. 11, 2009

(51) Int. Cl. G06Q 10/00; G06Q 50/00; G06F 9/46; G06N 5/02

(52) U.S. Cl. 705/8; 718/101; 706/47

(57) ABSTRACT

Systems, methods and articles of manufacture are disclosed for dispatching a workflow responsive to a request. A plurality of dispatch rules may be defined based on user input. Each of the plurality of dispatch rules may specify a workflow and an associated condition for invoking the respective workflow. Each workflow may manage a set of web services in a service-oriented architecture (SOA) system. The dispatch rules may be stored onto a storage device. A request may be received by the SOA system. The request may be evaluated against the plurality of dispatch rules. Further, a workflow may be determined based on the evaluation. The determined workflow may be dispatched responsive to the request, without requiring any source code modification and without requiring the request to specify the determined workflow.

### BACKGROUND OF THE INVENTION

1. Field of the Invention

The field of the invention relates to web services. More specifically, the field of the invention relates to dynamically binding a transaction to a business process workflow.

2. Description of the Related Art

Advances in computer technology are allowing many organizations to move towards a service-oriented architecture (SOA), where data flows and business logic of an organization are implemented using assemblies of web services. In general, web services are software components capable of being accessed via standard network protocols using a standardized messaging system. Such web services are typically capable of exchanging data with software applications that are written in various programming languages running on various platforms, thus enabling platform independent implementations of data flows and business logic of an organization.

In practice, an individual may utilize workflow modeling and runtime technologies and corresponding standards such as Business Process Execution Language (BPEL) to enable workflow-oriented applications, in which each business process is modeled as a workflow. A workflow is a series of steps involving a mix of services (software and human-provided) that may then be deployed and executed on a number of vendor provided, workflow runtime platforms, such as the IBM® WebSphere® Process Server. For example, a workflow may be a number of loosely coupled web services sending and receiving messages to perform an overall (business) process. A business process expert may link and sequence web services, in a process known as orchestration, to meet a new or existing business requirement. Workflow-oriented applications are central to the SOA pattern and allow a set of generic software services to be used in a variety of different combinations to solve an ever evolving set of business needs.

In workflow-oriented applications, a request submitted to a software system is “bound” to a given workflow that encodes a sequence of steps for servicing the request. In some systems, however, a number of workflows may all be able to service a given request. In one approach, a calling application may specify a desired workflow for servicing a request. However, the calling application would need to know in advance which workflow to specify. Alternatively, an overarching workflow may be provided solely for deciding which underlying workflow to invoke. However, new workflows and/or new workflow invocation logic would require the overarching workflow to be modified.

### SUMMARY OF THE INVENTION

One embodiment of the invention includes a method for dynamically dispatching a workflow. The method includes configuring one or more processors to perform an operation, which itself includes receiving, a plurality of dispatch rules each specifying at least one workflow and at least an associated condition for invoking the respective workflow. Each workflow manages a set of web services. That is, the workflow may orchestrate the execution fo multiple workflows in a coordinated manner. The operation also includes storing the dispatch rules onto a storage device, evaluating, by operation of the one or more computer processors, a transaction request against the plurality of dispatch rules, and determining at least one of the plurality of workflows to execute based on the evaluation. The operation also includes binding the transaction request to the determined workflow and dispatching the determined workflow with the bound transaction request for execution to invoke the web services managed by the determined workflow, in response to the transaction request.

Another embodiment of the invention includes a computer-readable storage medium containing a program, which, when executed, configures a processor to perform an operation for dynamically dispatching a workflow. The operation may generally include receiving a plurality of dispatch rules, each specifying at least one workflow and at least an associated condition for invoking the respective workflow. Each workflow manages a set of web services. The operation may generally include storing the dispatch rules onto a storage device, evaluating, by operation of the processor, a transaction request against the plurality of dispatch rules, and determining at least one of the plurality of workflows to execute based on the evaluation and binding the transaction request to the determined workflow. The operation may also include dispatching the determined workflow with the bound transaction request for execution to invoke the web services managed by the determined workflow, in response to the transaction request.

Still another embodiment of the invention includes a system having a processor and a memory containing a dispatching application which configured the processor to perform an operation for dynamically dispatching a workflow. The operation may generally include receiving a plurality of dispatch rules, each specifying at least one workflow and at least an associated condition for invoking the respective workflow. Each workflow manages a set of web services. The operation may also include storing the dispatch rules onto a storage device, evaluating, by operation of the one or more computer processors, a transaction request against the plurality of dispatch rules, and determining at least one of the plurality of workflows to execute, based on the evaluation. The operation may also include binding the transaction request to the determined workflow and dispatching the determined workflow with the bound transaction request for execution to invoke the web services managed by the determined workflow, in response to the transaction request.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a block diagram illustrating a system for dispatching a workflow to service a request, based on evaluation of a set of workflow selection rules, according to one embodiment of the invention.

FIG. 2 is a block diagram illustrating a functional view of a workflow dispatcher, according to one embodiment of the invention.

FIG. 3 is a flowchart depicting a method for identifying and dispatching one of several possible workflows, according to one embodiment of the invention.

FIG. 4 is a flowchart depicting a method for configuring a set of workflows and workflow selection rules and then using those rules to select the appropriate workflow to service a given request according to one embodiment of the invention.

FIG. 5 is a flowchart depicting a method for conveying how a set of workflow selection rules are evaluated to determine the singular workflow to service a specific request, according to one embodiment of the invention.

### DETAILED DESCRIPTION OF THE PREFERRED EMBODIMENTS

Embodiments of the present invention provide techniques for dynamically dispatching a transaction to a workflow based on a request. One embodiment of the invention provides a workflow dispatcher. In a particular embodiment, the workflow dispatcher may evaluate a received request, determine a workflow to execute based on the evaluation and a plurality of dispatch rules, and dispatch the request to the determined workflow. A user may configure the workflow dispatcher by updating the plurality of dispatch rules (e.g., by adding a new request type, by adding a new workflow, by changing an existing dispatch rule, etc.). In other words, the workflow dispatcher may be updated to handle new request types, new workflows, and new bindings between existing request types and existing workflows merely by updating a configuration (e.g., stored in a configuration file) for the workflow dispatcher, without requiring modification to any source code (e.g., of a client application to invoke a particular application for a given request type, or of an overarching workflow to handle a new binding between a request type and a workflow). Further, an initiator of the request (e.g., an application or a user) need not know in advance (i.e., of sending the request) which workflow to invoke.

The ability for the workflow dispatcher to handle new request types, new workflows, and new bindings between existing request types and existing workflows without requiring modification to any source code may be referred to as “dynamically dispatching.” That is, dynamic dispatching refers to an ability of the workflow dispatcher to accommodate new request types, workflows, and bindings on-the-fly.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

One embodiment of the invention is implemented as a program product for use with a computer system. The program(s) of the program product defines functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive) on which information is permanently stored; (ii) writable storage media (e.g., floppy disks within a diskette drive or hard-disk drive) on which alterable information is stored. Such computer-readable storage media, when carrying computer-readable instructions that direct the functions of the present invention, are embodiments of the present invention. Other media include communications media through which information is conveyed to a computer, such as through a computer or telephone network, including wireless communications networks. The latter embodiment specifically includes transmitting information to/from the Internet and other networks. Such communications media, when carrying computer-readable instructions that direct the functions of the present invention, are embodiments of the present invention. Broadly, computer-readable storage media and communications media may be referred to herein as computer-readable media.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

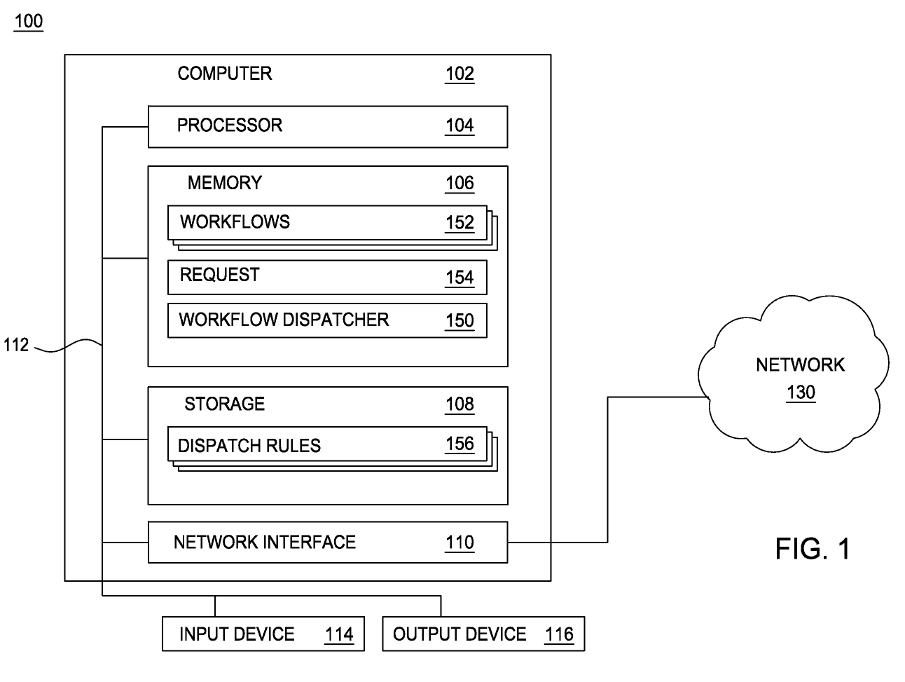

FIG. 1 is a block diagram illustrating a system 100 for dispatching a workflow to service a request, based on evaluation of a set of workflow selection rules, according to one embodiment of the invention. The networked system 100 includes a computer 102. The computer 102 is connected to other computers via a network 130. In general, the network 130 may be a telecommunications network and/or a wide area network (WAN). In a particular embodiment, the network 130 is the Internet.

The computer 102 generally includes a processor 104 connected via a bus 112 to a memory 106, a network interface device 110, a storage 108, an input device 114, and an output device 116. The computer 102 is generally under the control of an operating system (not shown). Examples of operating systems include UNIX, versions of the Microsoft Windows® operating system, and distributions of the Linux® operating system. (Note: Linux is at trademark of Linus Torvalds in the United States and other countries.) More generally, any operating system supporting the functions disclosed herein may be used. The processor 104 is included to be representative of a single CPU, multiple CPUs, a single CPU having multiple processing cores, and the like. Similarly, the memory 106 may be a random access memory. While the memory 106 is shown as a single entity, it should be understood that the memory 106 may comprise a plurality of modules, and that the memory 106 may exist at multiple levels, from high speed registers and caches to lower speed but larger DRAM chips. The network interface device 110 may be any type of network communications device allowing the computer 102 to communicate with other computers via the network 130.

The input device 114 may be any device for providing input to the computer 102. For example, a keyboard, keypad, light pen, touch-screen, track-ball, or speech recognition unit, audio/video player, and the like may be used. The output device 116 may be any device for providing output to a user of the computer 102. For example, the output device 116 may be any conventional display screen or set of speakers, along with their respective interface cards, i.e., video cards and sound cards (not shown). Although shown separately from the input device 114, the output device 116 and input device 114 may be combined. For example, a display screen with an integrated touch-screen, a display with an integrated keyboard, or a speech recognition unit combined with a text speech converter may be used.

The storage 108 may be a hard disk drive storage device. Although the storage 108 is shown as a single unit, the storage 108 may be a combination of fixed and/or removable storage devices, such as fixed disc drives, floppy disc drives, tape drives, removable memory cards, or optical storage. The memory 106 and the storage 108 may be part of one virtual address space spanning multiple primary and secondary storage devices.

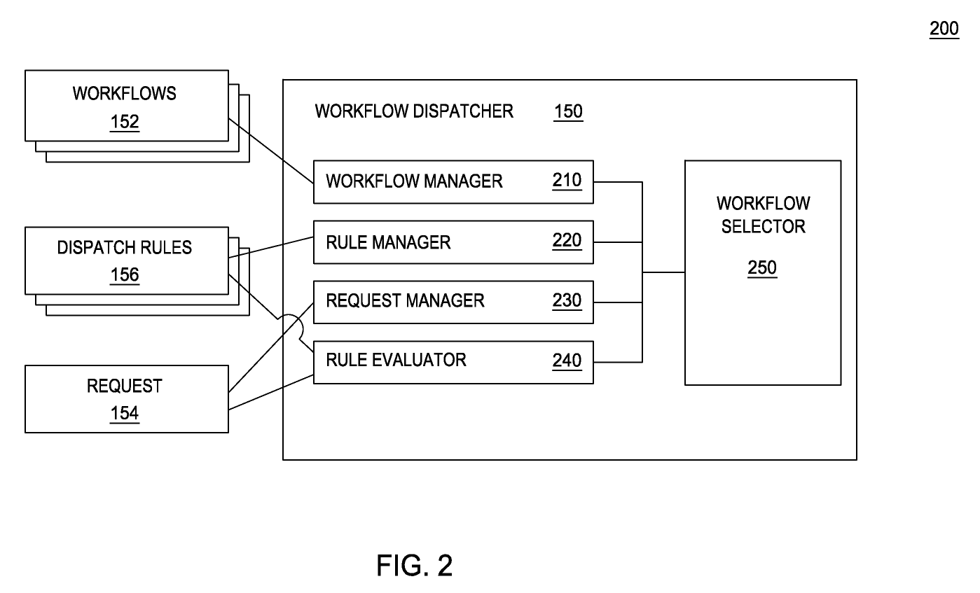

As shown, the memory 106 of the computer 102 includes workflows 152, a request 154, and a workflow dispatcher 150. Further, the storage 108 of the computer 102 includes dispatch rules 156. While embodiments herein are described with reference to dispatch rules 156 residing on the computer 102, other embodiments are broadly contemplated. For example, embodiments of the invention may be adapted to support dispatch rules 156 residing on another computer. FIGS. 2 through 5 and associated descriptions detail the structure and operation of the workflow dispatcher 150 running on the computer 102.

FIG. 2 is a block diagram 200 illustrating components of the workflow dispatcher 150 of FIG. 1, according to one embodiment of the invention. As shown, the workflow dispatcher 150 includes a workflow manager 210, a rule manager 220, a request manager 230, a rule evaluator 240, and a workflow selector 250.

In one embodiment, the workflow dispatcher 150 may provide a software application configured to execute within an SOA-based system. In particular, the dispatcher 150 may bind transactions to different workflows. For example, the dispatcher 150 may examine a request 154 and determine, based on the examined request and predefined dispatch rules 156, one of multiple workflows 152 to dispatch to service the request 154. The workflow dispatcher 150 may then dispatch the determined workflow 152 to service the request 154. The workflow dispatcher may receive the plurality of dispatch rules 156. In one embodiment, the plurality of dispatch rules 156 may be defined by a user. The plurality of dispatch rules 156 may specify how requests are serviced in the SOA-based system. For example, the dispatch rules 156 may specify a binding of a given request type to a particular workflow. That is, the dispatch rules 156 may associate the given request type to the particular workflow, such that the particular workflow is invoked to service requests of the given request type. The workflow dispatcher 150 may dynamically dispatch workflows 152 based on both a request 154 and the dispatch rules 156, without requiring any source code updates for the SOA-based system to handle new workflows, new request types, or new bindings, and without requiring the application or user initiating the request to know in advance which workflow to invoke.

In one embodiment, the workflow manager 210 handles workflows 152. Table I shows exemplary workflows 152 in a problem space of medical imaging systems:

TABLE I
Workflow example

| Workflow name | Description |
|---|---|
| ProcessCTSeries | Process a computed tomography (CT) image series |
| ProcessMRISeries | Process a magnetic resonance imaging (MRI) |
| | image series |

As shown, Table I includes a workflow 152 (i.e., ProcessCTSeries) for processing a CT image series from a CT scanner and a workflow 152 (i.e., ProcessMRISeries) for processing an MRI image series from an MRI scanner. Dispatch rules 156 may specify which workflow 152 (i.e., ProcessCTSeries or ProcessMRISeries) to dispatch responsive to a request 154. The images may be in DICOM (Digital Imaging and Communications in Medicine) format, according to one embodiment. The workflows may also stored processed images and make the process images available to radiologists for evaluation.

In one embodiment, the rule manager 220 defines dispatch rules 156 based on user input. Table II shows an example of dispatch rules:

TABLE II
Dispatch rule example

| Rule | Condition | Workflow name |
|---|---|---|
| 1 | Image type associated with request = “CT” | ProcessCTSeries |
| 2 | Image type associated with request = “MRI” | ProcessMRISeries |

As shown, Table II includes a dispatch rule to (i.e., Rule 1) dispatch the workflow for processing a CT image series upon determining that an image type associated with the request is “CT”. Table II further includes a dispatch rule (i.e., Rule 2) to dispatch the workflow for processing an MRI image series upon determining that an image type associated with the request is “MRI”. The workflow dispatcher 150 may evaluate a received request 154 against the dispatch rules 156 to determine a workflow to dispatch to service the received request 154. Further, the rule manager 220 may store the dispatch rules 156 in a configuration file. Table Ill shows an exemplary configuration file for a dispatch rule 156 (namely, “ProcessCTSeries” of Table II):

TABLE III
Configuration file example (XML)

```
<?xml version=“1.0” encoding=“UTF-8”?>
<bons0:WFDisptConfig xmlns:bons0=“http://com/amis/cfg/wf”
    xmlns:xsi=“http://www.w3.org/2001/XMLSchema-instance”
    xsi:schemaLocation=“http://com/amis/cfg/wf WFDisptConfig.xsd”>
    <WFCriteria>
        <Action>C-Store</Action>
        <WorkflowName>ProcessCTImage</WorkflowName>
        <Path>
            <Step feature=“Request”>
                <Condition>
                    <Feature>imageType</Feature>
                    <Operator>EQ</Operator>
                    <Value>CT</Value>
                </Condition>
            </Step>
        </Path>
    </WFCriteria>
</bons0:WFDisptConfig>
```

As shown, the configuration file is in Extensible Markup Language (XML) format and includes a node (e.g., WFCriteria) specifying a dispatch rule 156. Further, the configuration file includes a node (e.g., WorkflowName) specifying a name of a workflow to invoke (associated with the dispatch rule 156). The configuration file also includes a node (e.g., Condition) specifying a condition for invoking the workflow (e.g., imageType EQ CT, i.e., image type associated with the request is “CT”). While embodiments herein are described with reference to an XML configuration file, embodiments of the invention may be adapted to support other ways of storing dispatch rules (e.g., in a relational database management system) without departing from the scope of the invention.

A user (e.g., an administrator) may modify the dispatch rules 156 to alter the workflow dispatching behavior for a given class of requests. For example, suppose customers wish to see additional derivative image series for Magnetic Resonance Angiography (MRA) brain images. MRA is a specialized form of MRI focused on blood vessel structures. For example, the derivative image series may include three separate series each showing one of three vessel regions of the brain (e.g., to detect for a probability of an aneurysm). The user may modify the dispatch rules 156 as follows:

TABLE IV
Updated dispatch rule example

| Rule | Condition | Workflow name |
|---|---|---|
| 1 | Image type associated with request = “CT” | ProcessCTSeries |
| 2 | Image type associated with request = “MRI” | ProcessMRISeries |
| 3 | Image type associated with request = “MRI” | GenerateDerivSeries |
| | AND associated image sub-type = “MRA” | |
| | AND associated body part = “BRAIN” | |

As shown, Table IV includes a new dispatch rule (i.e., Rule 3) that invokes a workflow for generating derivative image series (namely, GenerateDerivSeries) if a request 154 includes an image type of “MRI”, an image sub-type of “MRA”, and a body part of “BRAIN” (i.e., if the request is to process an MRA brain scan). In one embodiment, the request manager 230 receives a request 154. Suppose the request manager 230 receives a request to process an MRA brain scan (i.e., a request with an associated image type “MRI”, an associated image sub-type “MRA” and associated body part “BRAIN”). The rule evaluator 240 may evaluate the received request 154 against the dispatch rules 156. That is, the rule evaluator 240 may evaluate the request (i.e., along with any associated data) against each condition of the dispatch rules 156. In this particular example, the rule evaluator 240 may determine that the condition for rule 1 of Table IV is not satisfied, but that the conditions for rules 2 and 3 are satisfied.

In one embodiment, the workflow selector 250 may determine one or more workflows to dispatch to service the request 154, based on the evaluation. For example, the workflow selector 250 may determine that the workflows associated with rules 2 and 3 of Table IV (namely, ProcessMRISeries and GenerateDerivSeries) are to be dispatched to service the request 154 (i.e., because the associated conditions are satisfied). That is, the workflow selector 250 may dispatch a workflow to process an MRI series associated with the request, followed by a workflow to generate derivative MRA brain image series associated with the request. Accordingly, the workflow dispatcher 150 may dynamically dispatch a workflow (e.g., GenerateDerivSeries) based on updated dispatch rules 156, without requiring any modification to source code (or compilation or deployment thereof), and without requiring the user or the application initiating the request to know in advance which workflow to invoke (e.g., GenerateDerivSeries).

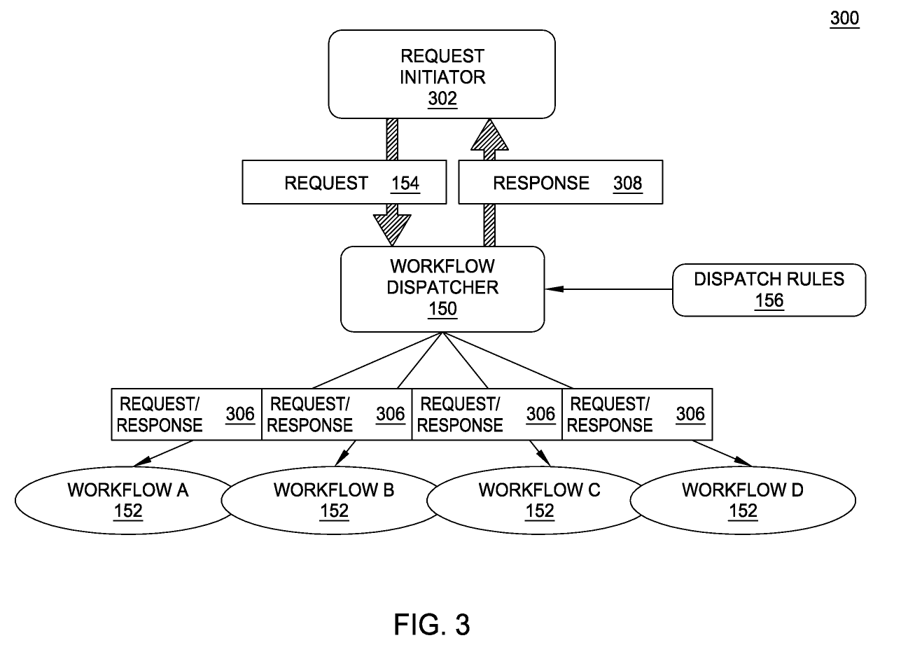

FIG. 3 is a flowchart depicting a method 300 for identifying and dispatching one of several possible workflows, according to one embodiment of the invention. As shown, the method 300 includes a request initiator 302. The request initiator 302 may be an application or a user initiating the request 154. The workflow dispatcher 150 receives the request 154 and, based on the request 154 and the dispatch rules 156, dispatches one or more of the workflows 154 (namely, workflows A through D of FIG. 3) to service the request 154 (e.g., via requests and/or responses 306). For example, the workflow dispatcher 150 may dispatch workflows ProcessMRISeries and GenerateDerivSeries of Table IV. The workflow dispatcher 150 then sends a response 308 to the request initiator 302, responsive to the request 154 and based on the responses 306 from the dispatched workflow(s) 152.

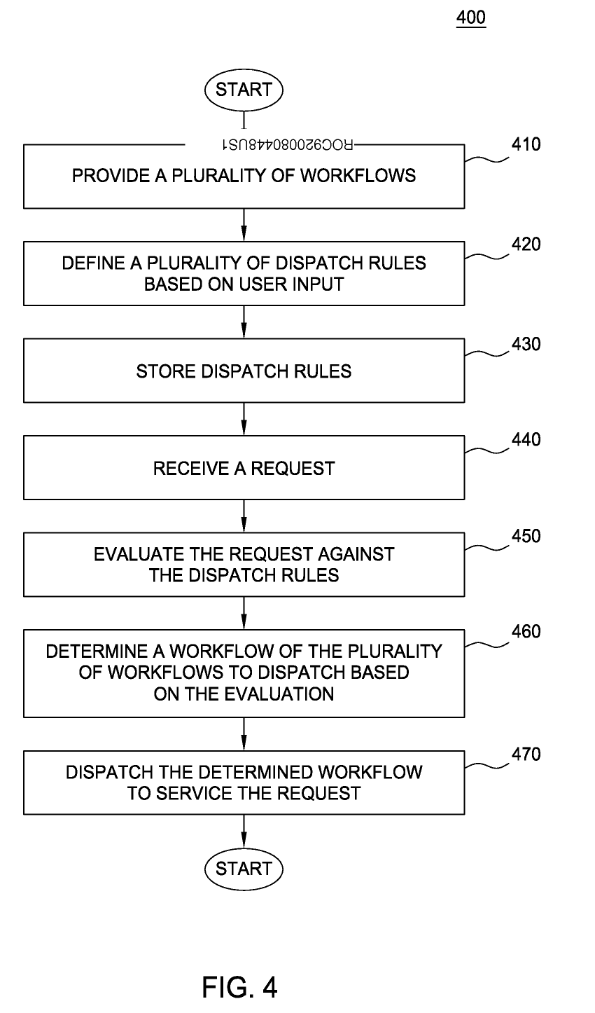

FIG. 4 is a flowchart depicting a method 400 for configuring a set of workflows and workflow selection rules and then using those rules to select the appropriate workflow to service a given request according to one embodiment of the invention. The steps of the method 400 are described in conjunction with the workflow examples of Table I and the dispatch rule examples of Table II.

As shown, the method 400 begins at step 410, where the workflow manager 210 identifies multiple workflows 152 available to processes user requests. In one embodiment, the collection of workflows may be expressly identified by a user. Alternatively, the collection of workflows may be identified based on a particular request (i.e., the workflows available for a given request may be request-dependent) For example, the workflow manager 210 may provide workflows for processing medical image, based on the image type associated with a given request (e.g., MRI and CT images). At step 420, the rule manager 220 receives dispatch rules 156 based on user input. For example, the rule manager 220 may configure a rule to invoke the workflow for processing MRI images, responsive to a request to process MRI images (e.g., rule 2 of Table II). At step 430, the rule manager 220 stores the dispatch rules. For example, the rule manager 220 may store the dispatch rules as a configuration file in the storage 108.

At step 440, the request manager 230 receives a request 154. For example, the request manager 230 may receive a request from an application to process MRI images. At step 450, the rule evaluator 240 evaluates the request 154 against the dispatch rules 156. For example, the rule evaluator 240 may determine that a condition is satisfied for invoking a workflow to process MRI images (e.g., rule 2 of Table II). The rule evaluator 240 may also determine that conditions are not satisfied for invoking other workflows (e.g., rules 1 and 3 of Table II). At step 460, the workflow selector 250 determines a workflow 152 to dispatch, based on the evaluation. For example, the workflow selector 250 may determine to dispatch the workflow for processing MRI images (e.g., ProcessMRISeries of Table II). At step 470, the workflow selector 250 dispatches the determined workflow 152 to service the request 154. For example, the workflow selector 250 may dispatch the workflow for processing MRI images. After step 470, the method 400 terminates.

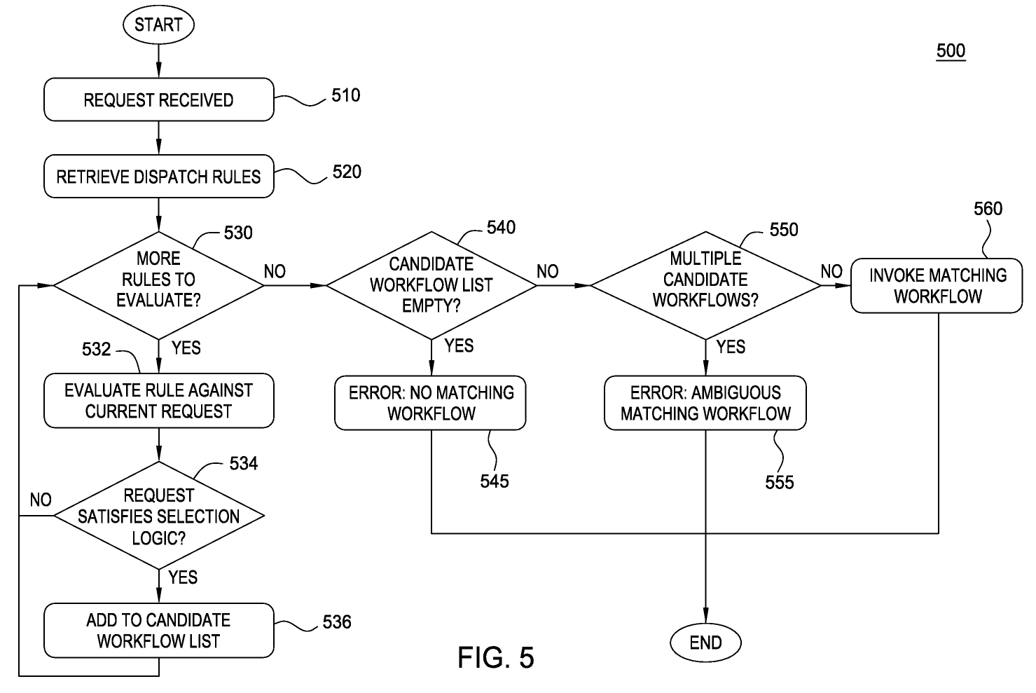

FIG. 5 is a flowchart depicting a method 500 for conveying how a set of workflow selection rules are evaluated to determine the singular workflow to service a specific request, according to one embodiment of the invention. The method 500 may be performed by the workflow dispatcher 150 of FIG. 1. The steps of the method 500 are described in conjunction with the workflow examples of Table I and the dispatch rule examples of Table II.

As shown, the method 500 begins at step 510, where the request manager 230 receives a request 154. For example, the request manager 230 may receive a request to process MRI images. At step 520, the rule manager 220 retrieves dispatch rules (or simply, “rules”) 156. Steps 530, 532, 534, and 536 evaluate each of the dispatch rules 156, adding to a candidate workflow list only those workflows associated with a satisfied condition (i.e., of the dispatch rules 156). At step 530, the rule evaluator 240 determines whether there are more rules to evaluate. If so, the method 500 proceeds to step 532, where the rule evaluator 240 evaluates the rule (i.e., the associated condition) against the request 154. For example, the rule evaluator 240 may evaluate whether the request includes an image type of “CT” (i.e., rule 1 of Table II). The rule evaluator may add a workflow to the candidate workflow list only if the respective rule is satisfied, according to one embodiment (step 536). The process of adding workflows to the candidate workflow list (steps 530, 532, 532, and 536) may repeat until all dispatch rules 156 are evaluated.

After step 530, if no dispatch rules 156 remain to be evaluated, the method 500 proceeds to step 540, where the workflow selector 250 determines whether the candidate workflow list is empty. If so, the workflow selector 250 may return an error that no workflow match exists (step 545). Otherwise, the method 500 proceeds to step 550, where the workflow selector 250 determines whether the candidate workflow list includes multiple candidate workflows. If so, the workflow selector 250 may return an error indicating that ambiguous workflow matches exist (step 555). In such an event, the workflow selector 250 may have a default response to an ambiguous match. For example, workflows may be assigned a ranking or otherwise be rated. In such a case, the workflow 152 with the highest ranking may be selected. Alternatively, the workflow selector 250 may prompt a user to select between multiple potential workflow choices. Of course, other approaches may be sued to resolve an ambiguous workflow match. In another embodiment, the workflow selector 250 may be configured to allow multiple workflows 152 to be dispatched responsive to a request 154. Further, each dispatch rule 156 may also specify a value representing an order (or priority) in which the respective workflow is to be dispatched (relative to workflows associated with other dispatch rules 156).

If the candidate workflow list includes exactly one workflow, the method 500 proceeds to step 560, where the workflow dispatcher 150 invokes the matching workflow 152. For example, the workflow dispatcher 150 may invoke the workflow to process MRI images (e.g., ProcessMRISeries of Table I). After step 545, step 555, or step 560, the method 500 terminates.

Of course, the embodiments described herein are intended to be illustrative and not limiting of the invention, and other embodiments are broadly contemplated. Those skilled in the art will recognize, for example, that embodiments of the invention may be adapted to support other requests, workflows, dispatch rules, and conditions (e.g., conditions involving a date and/or time, conditions involving a boolean OR operator, etc.).

Advantageously, embodiments of the invention dynamically dispatch a workflow responsive to a request. In one embodiment, a workflow dispatcher defines a plurality of dispatch rules based on user input. Each of the plurality of dispatch rules may specify a workflow and an associated condition for invoking the respective workflow. Each workflow may manage a set of web services in a service-oriented architecture (SOA) system. That is, the workflow may orchestrate the execution for multiple workflows in a coordinated manner. The workflow dispatcher may store the dispatch rules onto a storage device. Further, the workflow dispatcher may receive a request. The workflow dispatcher may evaluate the request against the plurality of dispatch rules. The workflow dispatcher may also determine a workflow to dispatch, based on the evaluation. The workflow dispatcher may dispatch the determined workflow responsive to the request, without requiring any source code modification and without requiring the request to specify the determined workflow.

While the foregoing is directed to embodiments of the present invention, other and further embodiments of the invention may be devised without departing from the basic scope thereof, and the scope thereof is determined by the claims that follow.

What is claimed is:

1. A computer-implemented method for dynamically dispatching a workflow, the method comprising configuring one or more processors to perform an operation comprising:
receiving a plurality of dispatch rules, each specifying at least one workflow and at least an associated condition for invoking the respective workflow, wherein each workflow manages a set of web services;
storing the dispatch rules onto a storage device;
evaluating, by operation of the one or more computer processors, a transaction request against the plurality of dispatch rules;
determining at least one of the plurality of workflows to execute based on the evaluation;
binding the transaction request to the determined workflow; and
dispatching the determined workflow with the bound transaction request for execution to invoke the web services managed by the determined workflow, in response to the transaction request.

2. The computer-implemented method of claim 1, wherein determining to execute at least one of the plurality of workflows based on the evaluation comprises determining that the transaction request satisfies one or more conditions associated with the selected workflow.

3. The computer-implemented method of claim 1, wherein the transaction request includes one or more data parameters to bind to the determined workflow.

4. The computer-implemented method of claim 1, where evaluating the request comprises evaluating a type of the request and data associated with the request.

5. The computer-implemented method of claim 1, wherein a first one of the dispatch rules specifies a priority value describing an order to invoke the associated workflow relative to workflows of other dispatch rules.

6. The computer-implemented method of claim 1, wherein the request is selected from at least a user request and an application request.

7. The computer-implemented method of claim 1, wherein at least one workflow processes images generated by a medical imaging system selected from at least a computed tomography (CT) image and a magnetic resonance imaging (MRI) image.

8. A computer-readable storage medium containing a program, which, when executed, configures a processor to perform an operation for dynamically dispatching a workflow, the operation comprising:
receiving a plurality of dispatch rules, each specifying at least one workflow and at least an associated condition for invoking the respective workflow, wherein each workflow manages a set of web services;
storing the dispatch rules onto a storage device;
evaluating, by operation of the processor, a transaction request against the plurality of dispatch rules;
determining at least one of the plurality of workflows to execute based on the evaluation;
binding the transaction request to the determined workflow; and
dispatching the determined workflow with the bound transaction request for execution to invoke the web services managed by the determined workflow, in response to the transaction request.

9. The computer-readable storage medium of claim 8, wherein determining to execute at least one of the plurality of workflows based on the evaluation comprises determining that the transaction request satisfies one or more conditions associated with the selected workflow.

10. The computer-readable storage medium of claim 8, wherein the transaction request includes one or more data parameters to bind to the determined workflow.

11. The computer-readable storage medium of claim 8, where evaluating the request comprises evaluating a type of the request and data associated with the request.

12. The computer-readable storage medium of claim 8, wherein a first one of the dispatch rules specifies a priority value describing an order to invoke the associated workflow relative to workflows of other dispatch rules.

13. The computer-readable storage medium of claim 8, wherein the request is selected from at least a user request and an application request.

14. The computer-readable storage medium of claim 8, wherein at least one workflow processes images generated by a medical imaging system selected from at least a computed tomography (CT) image and a magnetic resonance imaging (MRI) image.

15. A system, comprising:
a processor; and
a memory containing a dispatching application which configured the processor to perform an operation for dynamically dispatching a workflow, the operation comprising:
receiving a plurality of dispatch rules, each specifying at least one workflow and at least an associated condition for invoking the respective workflow, wherein each workflow manages a set of web services,
storing the dispatch rules onto a storage device,
evaluating, by operation of the processor, a transaction request against the plurality of dispatch rules,
determining at least one of the plurality of workflows to execute based on the evaluation,
binding the transaction request to the determined workflow, and
dispatching the determined workflow with the bound transaction request for execution to invoke the web services managed by the determined workflow, in response to the transaction request.

16. The system of claim 15, wherein determining to execute at least one of the plurality of workflows based on the evaluation comprises determining that the transaction request satisfies one or more conditions associated with the selected workflow.

17. The system of claim 15, wherein the transaction request includes one or more data parameters to bind to the determined workflow.

18. The system of claim 15, where evaluating the request comprises evaluating a type of the request and data associated with the request.

19. The system of claim 15, wherein a first one of the dispatch rules specifies a priority value describing an order to invoke the associated workflow relative to workflows of other dispatch rules.

20. The system of claim 15, wherein the request is selected from at least a user request and an application request.

21. The system of claim 15, wherein at least one workflow processes images generated by a medical imaging system selected from at least a computed tomography (CT) image and a magnetic resonance imaging (MRI) image.
